(19) United States
(12) Patent Application Publication
(10) Pub. No.: US 2006/0130662 A1
(43) Pub. Date: Jun. 22, 2006

(54) Air filter and method of filtering air in central heating and air conditioning system

(76) Inventor: Mario Digrato, Beaverton, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/014,938

(22) Filed: Dec. 17, 2004

(51) Int. Cl. B01D 46/00

(52) U.S. Cl. 96/224

(57) ABSTRACT

An air cleaner for use in a central heating and air conditioning system for a home or small building has a hollow shell that is configured to fit into the duct system associated with the heating and air conditioning system such that all or substantially all the air heated or cooled by the unit passes through the shell. Located in the shell is an ozone generator and an activated carbon filter. The activated carbon filter is located downstream of the ozone generator and substantially all of the heated or cooled air passes through the activated carbon filter. The activated carbon filter is sized to absorb a substantial portion of the ozone generated by the ozone generator.

### BACKGROUND AND SUMMARY OF THE INVENTION

This invention relates to an air filter having an ozone generator that produces ozone at a level that is above what is safe to introduce into a building in order to effectively kill bacteria and oxidize airborne particles and then removes a significant portion of this ozone from the air being filtered before it flows into the building being heated or cooled.

Eliminating airborne bacteria and particles in homes and other small buildings is an ongoing problem. Ozone is very effective at killing airborne bacteria and oxidizing airborne particles, however, the concentration of ozone that is required to do this effectively is harmful to humans, pets, and some plants living in the building. While portable ozone generators are available that effectively clean air in a small local area, ozone generators have not been effective in a central forced-air heating and air conditioning system. If they generate enough ozone to effectively kill airborne bacteria and oxidize airborne particles, the level of ozone is too high to be healthy for humans. If the amount of ozone they generate is reduced to a level that is safe for humans, it is too low to effectively kill bacteria and oxidize particles. What is needed, therefore, is a way to expose air being circulated in a building heating and air conditioning system to high enough levels of ozone to kill airborne bacteria and oxidize particles and still not pass this high concentration of ozone into the space being heated or cooled.

The subject invention accomplishes this by providing an air cleaner for a central heating or air conditioning system having a hollow shell that fits into a main duct through which substantially all of the air that is being heated or cooled passes. An ozone generator is located in the shell and an activated carbon filter is located in the shell downstream from the ozone generator. The activated carbon filter is arranged such that all the air being heated or cooled passes through it and is sized such that it absorbs a substantial portion of ozone from the air passing through it.

The foregoing and other objectives, features, and advantages of the invention will be more readily understood upon consideration of the following detailed description of a preferred embodiment, taken in conjunction with the accompanying drawings.

### BRIEF DESCRIPTION OF THE DRAWINGS

FIG. 1 is an exploded perspective view of an air filter embodying the subject invention.

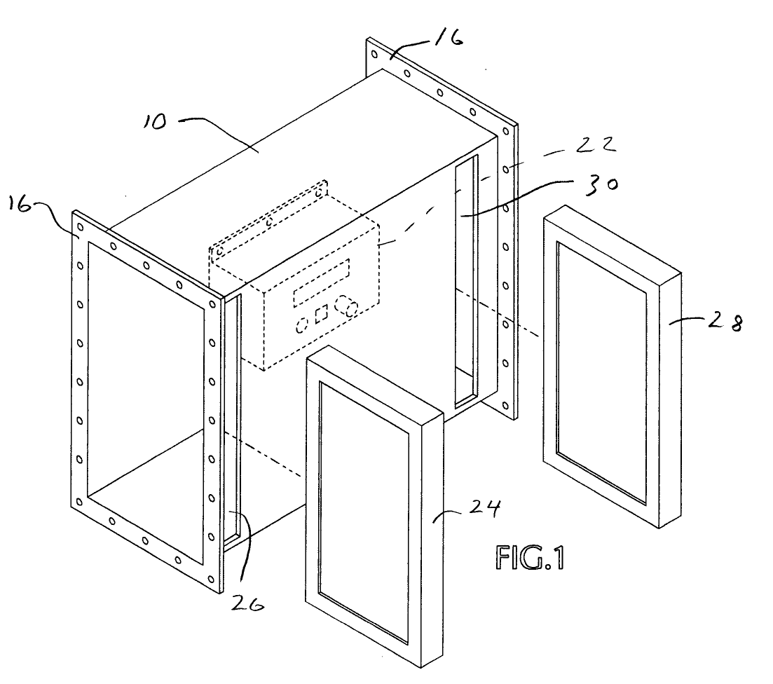

FIG. 2 is a side elevation view of the air filter of FIG. 1 installed in a heating or air conditioning system.

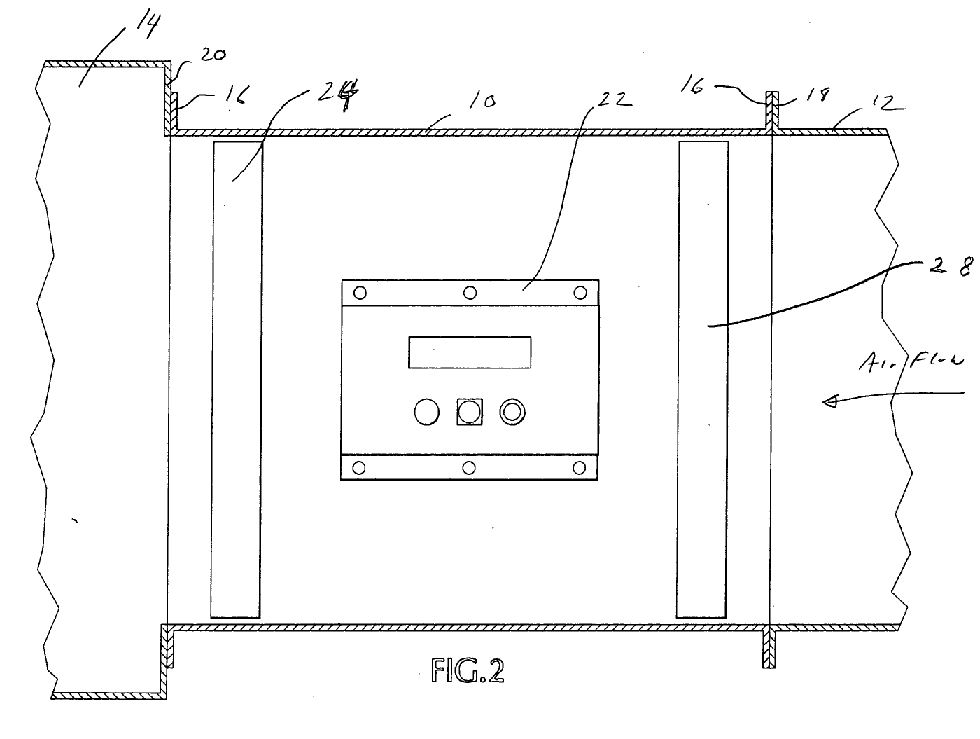

FIG. 3 is a side elevation view of the air filter installed in the heating or air conditioning system at another location.

### DETAILED DESCRIPTION OF A PREFERRED EMBODIMENT

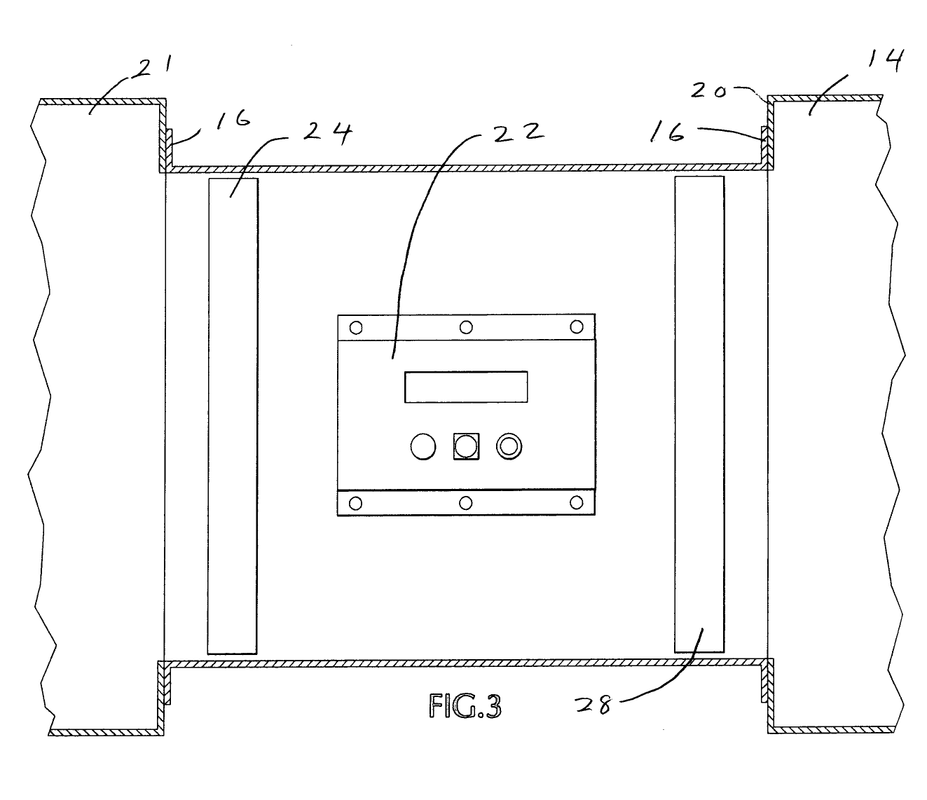

Referring to the drawings, a hollow shell 10 has a cross-sectional shape that matches the cross-sectional shape of an air return duct 12 just before it enters into a forced air central heating and air conditioning unit 14. In the embodiment illustrated, the shell is rectangular in cross-section, which is the shape of the air return duct in most heating and air conditioning systems. Located at each end of the shell is an annular flange 16. The flange at one end attaches to a mating flange 18 in the air return duct and the flange at the other end attaches to a mating flange 20 at the entrance of the heating and air conditioning unit. Alternatively, the shell could be configured to attach to an exit Plenum 21 of the heating and air conditioning unit before the air that has been heated or cooled is separated into multiple distribution ducts, as shown in FIG. 3. Either way all, or substantially all, of the air that is going to be or has been heated or cooled by the heating and air conditioning unit 14 passes through the shell 10.

Located in the shell 10 is an ozone generator 22. Preferably, it is a corona discharge ozone generator. The output of the ozone generator depends on the size of the building, or portion of a building, being served by the heating and air conditioning unit. However, as will be more fully described below, it needs to produce enough ozone to effectively kill bacteria and oxidize particles in the air while it passes through the shell. For an average size house, the ozone generator would need to generate between 250 and 500 milligrams of ozone per hour to do this. The Air-Duct 2000 ozone generator made by Air Zone, Inc. of Suffix, Va., would work well in this application. An ozone generator having a larger capacity could also be used if it is configured to operate below its capacity by running intermittently.

Also located in the shell 10, downstream from the ozone generator, is an activated carbon filter 24. A slot 26 is shown in the shell to allow the activated carbon filter to be easily replaced. A track system (not shown) may be provided to hold the activated carbon filter in place. The activated carbon filter preferably extends across the entire cross-sectional extent of the shell so that all, or substantially all, of the air that is heated or cooled by the heating and air conditioning unit 14 passes through the activated carbon filter after ozone from the ozone generator has been added to the air.

A mechanical filter 28 may also be located in the shell to remove large dust particles and the like from the air passing through the system. Preferably the mechanical filter is located upstream of the ozone generator 22 and activated carbon filter 24 so that these large particles do not reach the activated carbon filter and fill it up. A slot 30 is shown in the shell 10 to allow the mechanical filter to be easily replaced. As with the activated carbon filter, a track system (not shown) may be provided to hold the mechanical filter in place. Preferably the mechanical filter would be a hepa filter of a size that is less than 0.30 microns.

The ozone generator preferably has a control system (not shown) that causes it to operate only when the heating and air conditioning unit is operating. This can be accomplished by providing power to the ozone generator only when the fan in the heating and air conditioning unit is operating or by providing an airflow sensor (not shown), which only allows power to be provided to the ozone generator when there is a certain level of airflow in the shell. Control systems of this type are well known in the HVAC arts.

In operation, the ozone generator described above for an average size house generates between 250 and 500 milligrams of ozone per hour, which is far more ozone than would be healthy to introduce into the house being heated or cooled. As a result there is far more ozone than would normally be available in units of this type to kill bacteria and to oxidize material in the air being cleaned. This is possible because a significant portion of the ozone is trapped in the activated carbon filter and never reaches the interior of the house. In addition, this trapped ozone continuously replenishes the activated carbon filter, which extends its life. The activated carbon filter must be sized correctly relative to the output of the ozone generator to accomplish this. With an ozone generator that generates 250 to 500 milligrams of ozone per hour, it is desirable that the activated carbon filter capture between 50 percent and 90 percent of the ozone, and preferably it captures approximately 80 percent of the ozone. A portion of the remaining 20 percent will be used to oxidize particles in the distribution ducts, so that with an 80 percent capture less then 20 percent will actually reach the house. This means that roughly 35 to 80 milligrams of ozone per hour will be distributed into the interior of the house even though the full 250 to 500 milligrams of ozone per hour output of the ozone generator is available to kill bacteria and to oxidize particles internally in the heating and air conditioning system.

If it is desired to temporarily have the entire output of the ozone generator delivered into the house to clean the air in the house, the Activated Carbon Filter can be removed. In any event, ozone is short-lived and will mostly be depleted within 20 minutes or so.

The terms and expressions that have been employed in the foregoing specification are used therein are used as terms of description and not of limitation, and there is no intention, in the use of such terms and expressions, of excluding equivalents of the features shown and described or portions thereof, it being recognized that the scope of the invention is defined and limited only by the claims that follow.

1. An air cleaner for use in a central heating and air conditioning system comprising:
(a) A hollow shell that is configured to be placed into a heating/air conditioning system in a manner such that a substantial portion of the air that is heated or cooled by the heating/air conditioning system passes through said shell;
(b) An ozone generator that is located in said shell;
(c) An activated carbon filter that is located in said shell downstream of said ozone generator; wherein
(d) Substantially all of the air that is being heated or cooled passes through said activated carbon filter; and
(e) Said activated carbon filter is sized to absorb a substantial portion of the ozone generated by said ozone generator.

2. The air cleaner of claim 1 wherein said shell is configured to fit in a return air duct of said heating/air conditioning system.

3. The air cleaner of claim 1 wherein said shell is configured to fit into an exit plenum located downstream of where air is heated or cooled in said heating/air conditioning system.

4. The air cleaner of claim 1 wherein said ozone generator is a corona discharge generator.

5. The air filter of claim 1 including a mechanical filter that is located in said shell upstream of said ozone generator.

6. The air filter of claim 5 wherein said mechanical filter is a hepa filter.

7. The air filter of claim 5 where in said hepa filter is no larger 0.3 microns.

8. The air filter of claim 1 wherein said ozone generator generates between 250 to 500 milligrams of ozone per hour.

9. The air filter of claim 1 wherein said activated carbon filter absorbs between 50 percent and 90 percent of the ozone generated by said ozone generator.

10. The air filter of claim 1 wherein said activated carbon filter absorbs 80 percent of the ozone generated by said ozone generator.

11. A method for cleaning air that passes through a central heating and air conditioning system, comprising:
(a) Placing an ozone generator in a duct through which air from said heating and air conditioning system passes; and
(b) Placing an activated carbon filter in said duct downstream of said ozone generator, said activated carbon filter being sized to absorb between 50 and 90 percent of the ozone generated by the said ozone generator.

12. The method of claim 11 wherein said activated carbon filter is configured to absorb approximately 80 percent of the ozone generated by said ozone generator.

13. The method of claim 11 wherein said ozone generator generates between 250 and 500 milligrams of ozone an hour.

14. The method of claim 11 including placing a mechanical filter in said duct upstream of said ozone generator.

15. The method of claim 13 wherein said mechanical filter is a hepa filter.

16. The method of claim 11 wherein said ozone generator is a corona discharge ozone generator.
